(19) United States
(12) Patent Application Publication
(10) Pub. No.: US 2025/0355709 A1
(43) Pub. Date: Nov. 20, 2025

(54) RESOURCE ALLOCATION METHOD AND DEVICE

(71) Applicant: Lenovo (Beijing) Limited, Beijing (CN)

(72) Inventors: Xuan WANG, Beijing (CN); Ying XIONG, Beijing (CN)

(21) Appl. No.: 19/184,414

(22) Filed: Apr. 21, 2025

(30) Foreign Application Priority Data
May 14, 2024 (CN) 202410599665.2

(51) Int. Cl. G06F 9/50

(52) U.S. Cl. CPC G06F 9/5027

(57) ABSTRACT

A resource allocation method includes receiving a work instruction, analyzing the work instruction to determine an object corresponding to the work instruction that is one of at least two objects in an electronic device, and determining a resource allocation manner based on current resources of the electronic device and needed resource that is needed by the object.

### CROSS-REFERENCE TO RELATED APPLICATION

This application claims priority to Chinese Patent Application No. 202410599665.2, filed on May 14, 2024, the entire content of which is incorporated herein by reference.

### TECHNICAL FIELD

The present disclosure generally relates to the field of computer technologies and, more particularly, to a resource allocation method and device.

### BACKGROUND

With the development of artificial intelligence personal computers (AI PCs), popular large models such as text models, image models, and video models occupy a lot of system resources. Because of the inability to manage multiple models in a unified manner, the models will occupy resources when working, making it impossible to run the model that meet user needs and thereby reducing the user experience. In addition, the existence of multiple models makes it easy to call a wrong model for user work instructions.

### SUMMARY

In accordance with the disclosure, there is provided a resource allocation method including receiving a work instruction, analyzing the work instruction to determine an object corresponding to the work instruction that is one of at least two objects in an electronic device, and determining a resource allocation manner based on current resources of the electronic device and needed resource that is needed by the object.

Also in accordance with the disclosure, there is provided an electronic device, including a memory and a processor. The memory stores a computer program that, when executed by the processor, causes the processor to receive a work instruction, analyze the work instruction to determine an object corresponding to the work instruction that is one of at least two objects in the electronic device, and determine a resource allocation manner based on current resources of the electronic device and needed resource that is needed by the object.

Also in accordance with the disclosure, there is provided a non-transitory computer-readable storage medium storing a computer program that, when executed by a processor, causes the processor to receive a work instruction, analyze the work instruction to determine an object corresponding to the work instruction that is one of at least two objects in an electronic device, and determine a resource allocation manner based on current resources of the electronic device and needed resource that is needed by the object.

### BRIEF DESCRIPTION OF THE DRAWINGS

The drawings herein are incorporated into the specification and constitute a part of the specification. These drawings illustrate embodiments consistent with the present disclosure and are used together with the specification to illustrate the technical solution of the present disclosure.

FIG. 1 is a flow chart of a resource allocation method consistent with embodiments of the present disclosure.

FIG. 2 is a flow chart of a single-model resource allocation method consistent with embodiments of the present disclosure.

FIG. 3 is a flow chart of a multiple-model resource allocation method consistent with embodiments of the present disclosure.

FIG. 4 is a flow chart of a picture generation application resource allocation method consistent with embodiments of the present disclosure.

FIG. 5 is a flow chart of a text generation application resource allocation method consistent with embodiments of the present disclosure.

FIG. 6 is a schematic structural diagram of a resource allocation apparatus consistent with embodiments of the present disclosure.

FIG. 7 is a schematic structural diagram of an electronic device consistent with embodiments of the present disclosure.

### DETAILED DESCRIPTION OF THE EMBODIMENTS

Embodiments of the present disclosure are described hereinafter with reference to the accompanying drawings. The described embodiments are only some of the embodiments of the present disclosure, and not all of the embodiments. Based on the embodiments in the present disclosure, all other embodiments obtained by those skilled in the art without creative work are within the scope of the present disclosure.

In the following description, “some embodiments” are involved, which describe a subset of all possible embodiments, but it is understood that “some embodiments” may be the same subset or different subsets of all possible embodiments, and can be combined with each other without conflict.

In the following description, the terms “first/second/third” involved are only used as examples to distinguish different objects, and do not represent a specific order for the objects, and do not have a limitation on the order of precedence. It is understandable that “first/second/third” can be interchanged with a specific order or order of precedence when permitted, so that the embodiments of the present disclosure described here can be implemented in an order other than that illustrated or described here.

Unless otherwise defined, all technical and scientific terms used in the present disclosure have the same meaning as those generally understood by technicians in the technical field of this application. The terms used in the present disclosure are only for the purpose of describing the embodiments of the present disclosure and are not intended to limit the scope of the present disclosure.

The methods provided by the embodiments of the present disclosure may be executed by a mobile terminal device. The mobile terminal device may be a laptop, a tablet computer, a desktop computer, a set-top box, a mobile device (for example, a mobile phone, a portable music player, a personal digital assistant, a dedicated messaging device, a portable gaming device), or other types of terminals.

When multiple models in an electronic device are working, they will occupy system resources, resulting in one model that realizes user's needs may not be able to run and resulting in the problem of poor user experience of the electronic device. Further, the existence of multiple models is prone to calling a wrong model for user's work instructions.

The present disclosure provides a resource allocation method to at least partially alleviate the above problems. First, a work instruction sent by a user may be received, and a first object corresponding to the work instruction may be determined by analyzing the work instruction. According to current resources of the electronic device and resource needed by the first object, a resource allocation method of at least one object in the electronic device may be determined. On the one hand, by analyzing the work instruction, the user's intention may be obtained and the first object may be determined, such that the first object is called to complete the work instruction, thereby improving the accuracy of calling the first object and further improving the accuracy of realizing the user's intention. On the other hand, by determining the resource allocation manner of the at least one object in the electronic device, appropriate resources may be allocated to the first object such that the first object is able to run smoothly and output results to the user, thereby realizing unified management of multiple models and improving the user's experience.

The present disclosure provides a resource allocation method and apparatus, an electronic device, a storage medium, and a computer program product. In practical applications, the resource allocation method may be implemented by a resource allocation apparatus, and each functional entity in the resource allocation apparatus may be collaboratively implemented by hardware resources of the electronic device, such as computing resources (such as a processor) and communication resources (such as, for supporting various communication methods such as optical cables and cellular).

The present disclosure provides a resource allocation method. The functions implemented by the resource allocation method may be implemented by calling program codes by a processor in an electronic device (such as a controller). Of course, the program codes may be stored in a computer storage medium. It can be seen that the electronic device includes at least a processor and a storage medium.

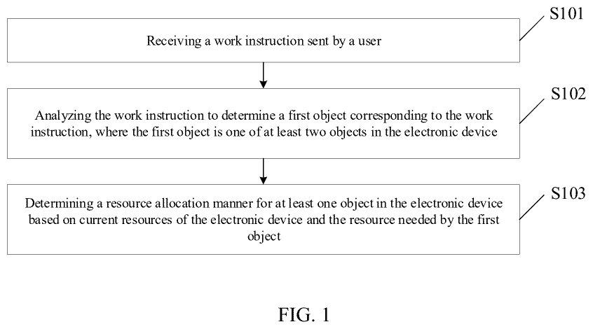

One embodiment of the present disclosure provides a resource allocation method. As shown in FIG. 1, which is a flow chart of the resource allocation method provided by the present embodiment, the method may include, but is not limited to, S101 to S103.

S101: Receiving a work instruction sent by a user.

The work instruction may be any voice input by the user, or any text and/or picture input by the user, such as, “generate a cat,” “a sentence describing spring,” inputting a picture of a cat, or inputting prompt words of “generate a video of multiple kittens playing,” etc. The work instruction may be an instruction input by the user on an interface of an application, and the application may be a text generation software, a picture generation software, or an intelligent assistant, etc.

S102: Analyzing the work instruction to determine a first object corresponding to the work instruction, where the first object is one of at least two objects in the electronic device.

The first object corresponding to the work instruction may be determined by a model application. For example, the model may be a text generation model, a picture generation model, a speech processing model, a game model, etc. For example, the user may input “generate a cat” in the text generation application and determine that the model corresponding to the work instruction is a picture generation model, or may input an instruction to query a location in the text generation application and determine that the model corresponding to the work instruction is a text generation model.

The first object corresponding to the work instruction may also be an application. The application may be an intelligent housekeeper, an intelligent management software, etc., or an application that does not need to call a model to implement functions (such as the Word document application, the Excel application, a video application, etc.). For example, the user may input “adjust the brightness of the display screen” in the intelligent assistant and determine that the object corresponding to the work instruction is the intelligent housekeeper application such that the intelligent housekeeper application intelligently adjusts the screen brightness. The user may input “help me open the Word document” and determine that the application corresponding to the work instruction is the Word application.

The at least two objects may all be models, or may all be applications; or may be partially models and partially applications.

Determining the first object corresponding to the work instruction and understanding the intention of the work instruction input by the user, may include but are not limited to: analyzing at least one of texts, pictures, or voices in the work instruction to determine keywords, matching the keywords with the at least one object in the electronic device, and obtaining the corresponding first object; or, inputting the work instruction into a pre-trained determination model and directly outputting the result of the first object.

S103: Determining a resource allocation manner for at least one object in the electronic device based on current resources of the electronic device and resource needed by the first object. The resource needed by an object or a model is also referred to as “needed resource.”

The current resources of the electronic device may be available resources or idle resources of hardware. The current resources may include only a first resource or a second resource; or may include both the first resource and the second resource. The first resource and the second resource may be video memory and/or memory, respectively. The resources of the electronic device may be the first resource as video memory and the second resource as memory; or the first resource as memory and the second resource as video memory. The video memory may include not only physical video memory, but also virtual a video memory space allocated from other storage spaces (hard disks), and memory may also include physical memory and virtual memory space allocated from other storage spaces (hard disks).

The resource needed by the first object may be any resource that ensures that the first object is able to execute the work instruction, for example, only the first resource, only the second resource, or both the first resource and the second resource.

It should be noted that resource needed by each object may need to meet a pre-set standard, which describes the model runtime memory or video memory specifications. For example, a text generation model may be defined as follows:
“VramThreshold”: 2.5,
“MaxVRamValue”: 5.7,
“RamThreshold”: 2.5,
“MaxRamValue”: 7,
“UMARamThreshold”: 8,
where “VramThreshold” indicates the minimum video memory occupancy with a discrete graphics card, “MaxVRamValue” indicates the maximum video memory occupancy with a discrete graphics card, “RamThreshold” indicates the minimum memory occupancy with a discrete graphics card, “MaxRamValue” indicates the maximum memory occupancy with a discrete graphics card, and “UMARamThreshold” indicates the maximum memory occupancy of the Uniform Memory Access (UMA) without a discrete graphics card. Depending on the hardware resources and operating environment, the model may also be run using the video memory occupancy alone.

The at least one object may include only a first model; or may include the first model and a second model; or may include the first model and other second applications.

It should be noted that the model may be a local model of the electronic device, and the processing of the model and the local model according to the user's work instructions may be performed locally on the electronic device. The resource allocation method for the at least one object may be processed locally on the electronic device.

In the embodiments of the present disclosure, on the one hand, by analyzing the work instruction, the user's intention may be obtained, the first object may be determined, and the first object may be called to complete the work instruction, which improves the accuracy of calling the first object and further improves the accuracy of realizing the user's intention. On the other hand, by determining the resource allocation manner of the at least one object in the electronic device, appropriate resources may be allocated to the first object such that it may run smoothly and output results to the user, thereby realizing unified management of multiple models and improving the user experience.

In some embodiments, determining the resource allocation manner for the at least one object in the electronic device based on the current resources of the electronic device and the resource needed by the first object (S103) may include:
S1031A: if the current resources of the electronic device meet the resource needed by the first object, executing the work instruction using the first object, and setting the state of the first object to a first state.

The state of one object in the electronic device may include the first state and a second state, and the resource occupancy of the object in the first state may be larger than the resource occupancy in the second state.

It should be noted that before using the first object to execute the work instruction, it may first be determined whether there is a loaded first object in the system. When there is one loaded first object, the work instruction may be directly executed using the first object. When there is no loaded first object, the first object may be loaded, and then the work instruction may be executed using the first object. Loading may mean loading a weight file of the first object, and the weight file of the first object may be the reason why the first object occupies the resources of the electronic device.

The first state may be a state in which the work instruction needs to be executed, where the first state may be a state in which the first object is working (MODEL_LOADED_WORKING). The second state may be a state in which the work instruction does not need to be executed, where the second state may be an idle state (MODEL_LOADED_IDLE), a suspended waiting state, or a model initialization state (MODEL_SERVICE_RUN) of the first object.

It should be understood that the resources occupied when executing the work instruction may be greater than the resources occupied when not executing the work instruction, such that the resource occupation in the first state may be greater than the resource occupation in the second state.

In one embodiment, the electronic device may be in a single-model working mode, and only one first object may be needed to execute a work instruction. When the current resources of the electronic device meet the resource needed by the first object, the first object may be used to execute the work instruction, and the state of the first object may be a working state and a loading state. The first object may be the first object that starts to be loaded or the first object that has been loaded and executed.

In another embodiment, the electronic device may be in a multi-model working mode, and the current resources of the electronic device may meet the resources needed by at least two first objects. The at least two first objects may be different objects, and the corresponding work instructions may be respectively executed using the at least two first objects, where the state of each first object may be a working state or a loading state.

In the embodiments of the present disclosure, when the current resources of the electronic device meet the resource needed by the first object, the work instruction may be directly executed on the current resources of the electronic device using the first object, and the state of the first object may be set to the first state. Therefore, by directly allocating the current resources to the first object, the preparation time for the first object to execute the work instruction may be shortened, thereby shortening the execution time of the work instruction, such that the user may quickly obtain the result. Further, the first object may be quickly allocated with appropriate resources to make it run smoothly, to realize the unified management of multiple models and improve the user experience.

In some embodiments, determining the resource allocation manner for the at least one object in the electronic device based on the current resources of the electronic device and the resource needed by the first object (S103) may include:
S1031B: if the current resources of the electronic device do not meet the resource needed by the first object and attribute information of a second object of the electronic device meets a preset condition, allocating the resources occupied by the second object to the first object to meet the resource needed by the first object to execute the work instruction, and setting the state of the first object to the first state, where the resource occupation of the object in the first state may be greater than the resource occupation in the second state.

The reason why the current resources of the electronic device do not meet the resource needed by the first object may be that other models are working or other applications (such as game software) occupy system resources.

The second object may be other models or applications that occupy resources.

In one embodiment, when the electronic device is in a single-model working mode, the current resources of the electronic device may not meet the resource needed by the first object, because other applications (the second object) in the electronic device are running. When the attribute information of one running application (the second object) meets the preset condition, the resources occupied by the second object may be allocated to the first object to meet the resource needed by the first object to execute the work instruction.

In another embodiment, the electronic device may be in a multi-model working mode, and the current resources of the electronic device may not meet the resource needed by the first object. When there are another model (the second object) working, when the attribute information of the other model meets the preset condition, the resources occupied by the other model may be allocated to the first object to meet the resource needed by the first object to execute the work instruction.

In the embodiments of the present disclosure, when the current resources of the electronic device do not meet the resource needed by the first object, and the attribute information of the second object meets the preset conditions, the resources occupied by the second object may be allocated to the first object, and the state of the first object may be the first state, such that the first object executes the work instruction. Therefore, by allocating appropriate resources to the first object according to the attribute information of the second object for it to complete the work, unified management of multiple models may be achieved, and the user experience may be improved.

In some embodiments, the attribute information of the second object may include at least one of the state of the second object or the priority of the second object. The attribute information of the second object meeting the preset condition may include at least one of the state of the second object may include that the second state or the priority of the first object is higher than the priority of the second object.

In some embodiments, the state in the attribute information of the second object may include the first state and the second state. The first state may be a working state, and the first state of the second object may be the working state. The second state may be a non-working state, and the second state of the second object may be an idle state, a waiting state, or an object initialization state.

It should be noted that objects with higher priority may be run first.

In some embodiments, determining whether the attribute information of the second object meets the preset condition may include: the attribute information of the second object meets the preset condition when the state of the second object is the second state; the attribute information of the second object meets the preset condition when the priority of the second object is lower than the priority of the first object; or the second object meets the preset condition when the state of the second object is the first state and the priority of the second object is lower than the priority of the first object.

When the first object and the second object are both models, the priority of the first object being higher than the priority of the second object may include that the priority of the first model is higher than the priority of the second model. The priority may be set by setting the attributes of the model. For example, the user may set the priority of the text generation model to be higher than the priority of the picture generation model in the interface in advance, or set the priority of the text generation model to be higher than the priority of the picture generation model according to the user's historical usage. The two models may be two different models in the same application. For example, the text generation model and the picture generation model may be called in the text generation application. Or, the two models may be models called by two applications respectively, such as the game model in the game software and the picture generation model in the picture generation application. Determining the priority of the two models may include: performing analysis based on the content or type of the work instruction sent by the user, to determine that the priority of the current work instruction or the current task is higher. The priority of the first object determined based on the current work instruction may be relatively high. For example, the first object may be a picture generation model, and the second object may be a voice model. The priority of generating pictures may be higher than that of generating voices. The picture generation model may be called according to the work instruction for generating pictures. For another example, the first object may be a voice model, and the second object may be a game model. The priority of generating voices may be higher than that of generating games, and the voice model may be called according to the work instruction for generating voices. In some other embodiments, determining the priority of the two models may include setting the priority of the application using the first model is higher than the priority of the application using the second model. For example, the text generation application may call the text generation model, the picture generation application may call the picture generation model, and the priority of picture generation application may be higher than the priority of text generation application. Or, the text generation application may call the text generation model, the voice application may call the voice model, and the priority of the text generation application may be higher than the priority of voice application.

When the first object is a model and the second object is an application, the priority of the first object being higher than the priority of the second object may include: the user inputs the work instruction in the interface of the target application, and determining that the priority of the first model is higher than the second application when the priority of the target application is higher than the second application and the work instruction of the target application corresponds to the first model. For example, the first object may be a picture generation model, and the second object may be a Word document. When the priority of the picture generation application is higher than that of the Word document, it may be determined that the priority of the text generation model is higher than the priority of the Word document. Or, the first object may be a voice model, and the second object may be a game application. When the priority of the voice application is higher than that of the game application, it may be determined that the priority of the voice model is higher than that of the game application. The priority of the first object being higher than the priority of the second object may also include: analyzing the content or type of the work instruction sent by the user, determining that the priority of the current work instruction or the current task is higher than the currently executed task of the second application, and then determining that the priority of the first model is higher than the second application. For example, the first object may be a living text model, and the second object may be a game application. When the work instruction sent by the user is “query what the four great classics are,” it should be understood that the priority of querying information is higher than that of the game, and then it may be determined that the priority of the living text model is higher than that of the game application. For another example, the first object may be a voice model, and the second object may be a game application. When the work instruction sent by the user is “play music,” it should be understood that the priority of playing music is lower than the priority of playing games, and then it may be determined that the priority of the voice model is lower than the priority of the game application.

When allocating the resources occupied by the second object to the first object, it may be necessary to ensure that the state of the second object is the second state. When the state of the second object is the first state, it may be necessary to switch the first state to the second state. For example, when the second object is a model, it may be uninstalled to enter the object initialization state. When the second object is an application, it may be switched to the waiting suspension state. When the state of the second object is the second state, such as the idle state, it may be necessary to switch a substate of the second state of the second object, that is, the idle state, to another substate of the second state, that is, the initialization state.

In the embodiments of the present disclosure, the actual situation of the second object may be judged by using different attribute information such as the state or priority of the second object, and the resources may be allocated to the first object according to the actual situation. Therefore, by combining the specific situation to determine whether to allocate resources to the first object, it may be avoided to directly allocate the resources of the second object to the first object, which affects the work of the second object, improves the accuracy and wide applicability of resource allocation, and further improves the user experience. The working state of each object may be effectively planned, and the multi-object workflow may be effectively arranged in conjunction with the system resources.

In some embodiments, the resource allocation method may further include:
S201: when the execution of the work instruction using the first object is completed, setting the state of the first object to the second state, where the resource occupancy of the object in the first state may be greater than the resource occupancy in the second state.

In some embodiments, after determining the resources of the first object to execute the work instruction based on the current resources of the electronic device and the resource needed by the first object, the work instruction may be executed using the first object, and, after the execution of the work instruction is completed, the first object may need to be switched from the first state to the second state.

In the embodiments of the present disclosure, after the execution of the work instruction using the first object is completed, the first object may be set to the second state, to reduce the resource occupancy of the first object, free up resources for other objects, facilitate other objects to execute the work instruction, and improve the effect of the electronic device executing the work instruction. The working state of each object may be effectively planned, and the multi-object workflow may be effectively arranged in conjunction with the system resources.

In some embodiments, the method further includes S301 to S303 after S201.

S301: After each time the state of the first object is set to the second state, starting a first timer.

The first timer may be used to record the duration of the first object executing the work instruction, and the duration of the first timer may be any pre-set appropriate value, such as 60 seconds (s), or 30 s.

It should be noted that here, setting the state of the first object to the second state may include setting the first object to the waiting state or the idle state.

S302: When the first timer times out and no work instruction for the first object is received, releasing the resources occupied by the first object;

It should be noted that the resources occupied by the first object may be essentially the occupied resources of the weight files of the first object. Therefore, releasing the resources occupied by the first object may include uninstalling the first object. To quickly start the first object next time, only some weight parameter files in the first object may be uninstalled, or all weight parameter files in the first object may be uninstalled.

S303: When the first timer does not time out and a work instruction for the first object is received, stopping the first timer, updating the state of the first object to the first state, and executing the work instruction using the first object.

In one embodiment, each time the first object completes the execution of the work instruction, a timer may be started to determine whether a work instruction for the first object is received within the preset duration of the timer. When no work instruction is received, the resources occupied by the first object may be released by uninstalling the weight files of the first object. When a work instruction is received, the timer may be stopped, and the work instruction may be executed using the first object. After the work instruction is executed, the timer may be restarted to wait for the work instruction within the expected duration. Therefore, an automatic uninstalling strategy may be added through the timer, the strategy of loading and uninstalling the model weight files may be optimized, resources may be released in time according to actual conditions, the efficiency of the electronic device's intact work instructions may be improved, and the user experience may be improved.

In some embodiments, the resource allocation method may further include S401 to S405.

S401: If the current resources of the electronic device include a first resource, determining whether the first resource is greater than the resource needed by the first object;

The first resource may be a free or available resource on a central processing unit (CPU), i.e., a memory; or a free or available resource on a graphics processing unit (GPU), i.e., a video memory.

S402: If the first resource is greater than the resource needed by the first object, determining that the current resources of the electronic device meets the resource needed by the first object;

In some embodiments, when the first resource is a video memory and the available resources on the video memory are greater than the resource needed by the first object, it means that the current resources of the electronic device meet the resource needed by the first object. When the first resource is a memory and the available resources on the memory are greater than the resource needed by the first object, it may be determined that the current resources of the electronic device meet the resource needed by the first object.

It should be noted that the computing speed of the video memory in the electronic device is greater than the computing speed of the memory, such that the free or available resources on the video memory may be judged first, and when both the video memory and the memory meet the resource needed by the first object, the video memory may be allocated to the first object first.

S403: If the first resource is less than the resource needed by the first object, determining a second resource in the current resources of the electronic device.

In some embodiments, when the first resource is video memory, the second resource may be internal memory, and the idle value or available value of the video memory may be less than the resource needed by the first object. The idle value or available value of the internal memory in the current resources of the electronic device may be calculated. In another embodiment, the first resource may be the internal memory, and the second resource may be the video memory.

S404: If the sum of the first resource and the second resource is greater than the resource needed by the first object, determine that the current resources of the electronic device meet the resource needed by the first object;

S405: If the sum of the first resource and the second resource is less than the resource needed by the first object, determine that the current resources of the electronic device do not meet the resource needed by the first object.

In some embodiments, when the resources of the video memory plus the internal memory are greater than the resource needed by the first object, it may be determined that the current resources of the electronic device meet the resource needed by the first object. When the resources of the video memory plus the internal memory are less than the resource needed by the first object, it may be determined that the current resources of the electronic device do not meet the resource needed by the first object.

It should be noted that when judging whether the resource needed by the first object are met based on the sum of the first resource and the second resource, both the first resource and the second resource may need to meet the minimum threshold in the first object standard. For example, in the standard specification of the text generation model, the minimum video memory occupancy with a discrete graphics card may be 2.5, the minimum memory occupancy with a discrete graphics card may be 2.5, the maximum video memory occupancy with a discrete graphics card is 5.7, and the maximum memory occupancy with a dedicated card is 7. Therefore, the video memory and memory in the current resources of the electronic device may need to be greater than or equal to 2.5. If the video memory of the electronic device is 2.5, the memory may need to be 7. If the video memory of the electronic device is greater than 2.5, the memory may be less than 7. In other words, the first resource and the second resource must be greater than the minimum threshold defined in the standard specification of the first object. As one resource increases, the other resource may decrease, but it cannot be less than the minimum threshold.

In the embodiments of the present disclosure, the current resources of the electronic device may be determined comprehensively based on the first resource and the second resource, and the two resources may be used to determine whether the current resources of the electronic device meet the resource needed by the first object, thereby increasing the probability of allocating resources to the first object, further improving the efficiency of the first object in executing work instructions, and improving the user experience.

In some embodiments, the resource allocation method may also include S501 to S503.

S501: If the current resources of the electronic device do not include the first resource, determining whether the second resource in the current resources of the electronic device is greater than the resource needed by the first object.

In some embodiments, the first resource may be video memory. When the current resources of the electronic device do not include video memory, it may be determined whether the memory in the current resources of the electronic device is greater than the resource needed by the first object.

S502: If the second resource is greater than the resource needed by the first object, determining that the current resources of the electronic device meet the resource needed by the first object.

S503: If the second resource is less than the resource needed by the first object, determining that the current resources of the electronic device do not meet the resource needed by the first object.

In some embodiments, when the current resources of the electronic device only have memory resources, and the memory is greater than the resource needed by the first object, it may be determined that the current resources of the electronic device meet the resource needed by the first object; otherwise, it may be determined the current resources of the electronic device do not meet the resource needed by the first object.

In the embodiments of the present disclosure, when the current resources of the electronic device do not include the first resource, the second resource may be used to allocate resources to the first object, which increases the probability of allocating resources to the first object, further improves the efficiency of the first object in executing work instructions, and improves the user experience.

In some embodiments, allocating the resources occupied by the second object to the first object in S1031B may include S10311B and S10312B.

S10311B: Displaying a prompt message on a screen of the electronic device, where the prompt message is used to prompt the user whether to allocate the resources occupied by the second object to the first object.

The prompt message may be in a form of voice or text. The prompt message may carry information about the work instructions currently executed by the electronic device.

S10312B: Allocating the resources occupied by the second object to the first object in response to a resource allocation operation instruction triggered by the user.

The operation instruction may be an input text instruction or a voice instruction.

Exemplarily, after the user issues a work instruction, when the electronic device determines that the current resources do not meet the resource needed by the first object and the attribute information of the second object meets the preset condition, the prompt message may be displayed on the screen or a voice prompt may be given to the user to ask whether he agrees to allocate the resources occupied by the second object to the first object. When the user agrees, the resources occupied by the second object may be allocated to the first object. When the user disagrees, the resources occupied by the second object may not be allocated to the first object, and the first object may not execute the work instruction.

In the embodiments of the present disclosure, by prompting the user whether to agree to allocate the resources occupied by the second object to the first object, the work instruction may be executed after receiving the user's consent instruction, to avoid the user from mistakenly sending the work instruction or the user forgetting the work instruction currently being executed by the electronic device, thereby affecting the completion of the work task of other objects at present.

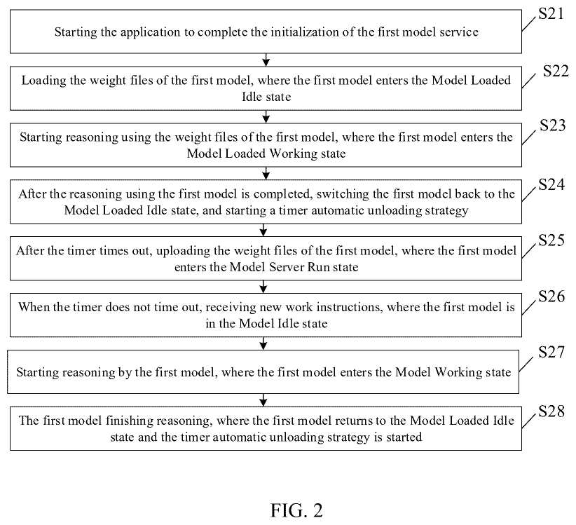

One embodiment of the present disclosure provides another resource allocation method. As shown in FIG. 2, which is a flow chart of a method for allocating resources to a single model, the method may include:
S21: Starting the application to complete the initialization of the first model service, where the application refers to an application that needs a model to implement functions;
S22: Loading the weight files of the first model, where the first model enters the Model Loaded Idle state;
S23: Starting reasoning using the weight files of the first model, where the first model enters the Model Loaded Working state;
S24: After reasoning using the first model is completed, switching the first model back to the Model Loaded Idle state, and starting a timer automatic uninstalling strategy;
S25: After the timer times out, uploading the weight files of the first model, where the first model enters the Model Server Run state;
S26: When the timer does not time out, receiving new work instructions, where the first model is in the Model Idle state;
S27: Starting reasoning by the first model, where the first model enters the Model Working state; and
S28: The first model finishing reasoning, where the first model returns to the Model Loaded Idle state and the timer automatic uninstalling strategy is started.

In some embodiments, the multi-model electronic device may include a multi-model scheduling management model for managing the current working state of each model, system resource detection, distribution of each model's working instructions, and dynamic loading or uninstalling of models.

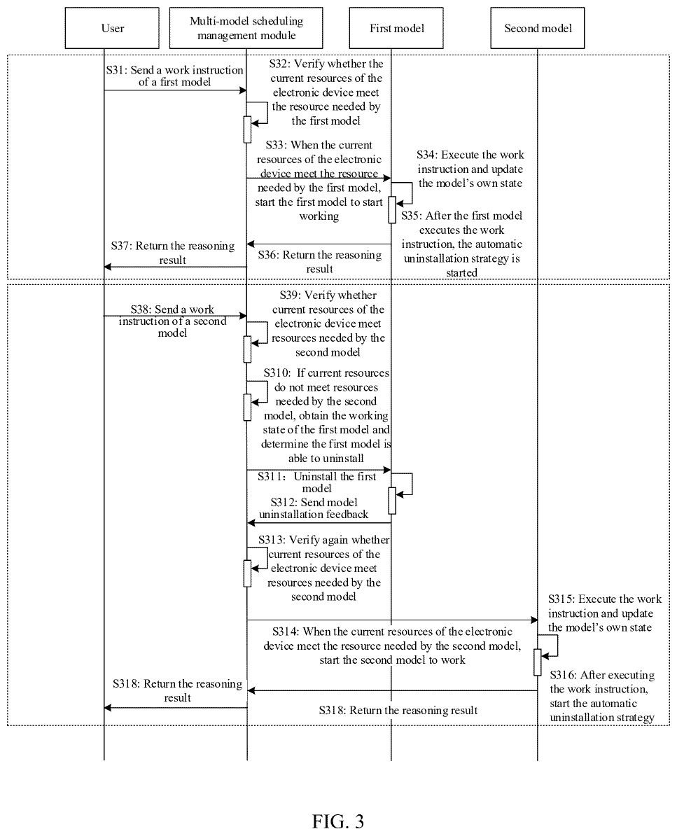

One embodiment of the present disclosure provides another resource allocation method. As shown in FIG. 3, which is a flow chart of a method for allocating resources to a single model, the method may include S31 to S318.

S31: The user sends a work instruction of a first model to the multi-model scheduling management module in the electronic device.

Here, the first model may be the first object.

S32: The multi-model scheduling management module verifies whether the current resources of the electronic device meet the resource needed by the first model.

S33: When the current resources of the electronic device meet the resource needed by the first model, the multi-model scheduling management module starts the first model to start working.

S34: The first model executes the work instruction and updates the model's own state.

S35: After the first model executes the work instruction, the automatic uninstallation strategy is started.

S36: The first model returns the reasoning result to the multi-model scheduling management module.

S37: The multi-model scheduling management module returns the reasoning result to the user.

S38: The user sends a work instruction of a second model to the multi-model scheduling management module.

S39: The multi-model scheduling management module verifies whether the current resources of the electronic device meet the resource needed by the second model.

S310: IF the current resources of the electronic device do not meet the resource needed by the second model, the multi-model scheduling management module obtains the working state of the first model and determines that the first model is able to be uninstalled.

S311: The multi-model scheduling management module uninstalls the first model.

S312: The first model sends model uninstallation feedback to the multi-model scheduling management module.

S313: The multi-model scheduling management module verifies again whether the current resources of the electronic device meet the resource needed by the second model.

S314: When the current resources of the electronic device meet the resource needed by the second model, the multi-model scheduling management module starts the second model to work.

S315: The second model executes the work instruction and updates the model's own state.

S316: After the second model executes the work instruction, it starts the automatic uninstallation strategy.

S317: The second model returns the reasoning result to the multi-model scheduling management module.

S318: The multi-model scheduling management module returns the reasoning result to the user.

Next, the resource allocation method provided by the present disclosure is described through a complete embodiment.

The resource allocation method provided by the present disclosure may achieve unified management of multiple models, thereby allocating appropriate resources for them to use to complete the work, and at the same time may optimize the strategy of loading and uninstalling model weight files to improve user experience.

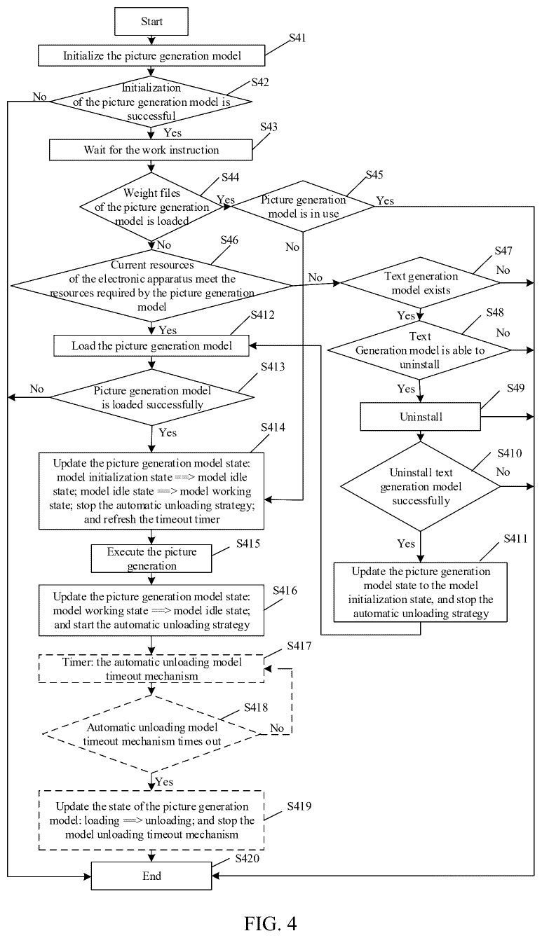

The resource allocation method is described in detail below using the picture generation application as an example. FIG. 4 is a flow chart of a resource allocation method for a picture generation application. As shown in FIG. 4, the method includes S41 to S420.

S41: Initialize the picture generation model.

It should be understood that the model used in the picture generation application may be a picture generation model, which can only generate images. The picture generation model may be the first object.

S42: Determine whether the initialization of the picture generation model is successful. If successful, execute S43; otherwise, execute S420.

S43: Wait for the work instruction.

S44: Determine whether the weight files of the picture generation model is loaded. If loaded, execute S45; otherwise, execute S46.

S45: Determine whether the picture generation model is in use. If not, execute S414; otherwise, execute S420.

S46: Determine whether the current resources of the electronic device meet the resource needed by the picture generation model. If yes, execute S412; otherwise, execute S47.

S47: Determine whether a text generation model exists. If so, execute S48; otherwise, execute S420.

The text generation model may be the second object.

S48: Determine whether the text generation model is able to be uninstalled. If so, execute S49; otherwise, execute S420.

The uninstall condition may be that the text generation model has been loaded and is in an idle state, or in a suspended state.

S49: Uninstall the text generation model.

S410: Determine whether the text generation model is successfully uninstalled. If successful, execute S411; otherwise, execute S420.

S411: Update the picture generation model state to the model initialization state, and stop the automatic uninstalling strategy.

S412: Load the picture generation model.

S413: Determine whether the picture generation model is loaded successfully. If loaded successfully, execute S414; otherwise, execute S420.

S414: Update the picture generation model state: model initialization state==>model idle state; model idle state==>model working state; stop the automatic uninstalling strategy; and refresh the timeout timer.

S415: Execute the picture generation.

S416: Update the picture generation model state: model working state==>model idle state; and start the automatic uninstalling strategy.

S417: Enable the automatic uninstalling model timeout mechanism.

S418: Determine whether the automatic uninstalling model timeout mechanism has timed out. If it has timed out, execute S419; otherwise, execute S417.

It should be understood that after the automatic uninstalling model timeout mechanism is turned on, it may be detected whether a new work instruction is received within the timeout period. When a new work instruction is received, the timeout mechanism may be stopped, the state of the first model may be updated, and the new work instruction may be executed using the first model. After the work instruction is executed, the timeout mechanism may be restarted to continue to detect whether there is a new work instruction. If no new work instruction is received after the timeout mechanism ends, S419 may be executed.

S419: Update the state of the picture generation model: loading==>uninstalling; and stop the model uninstalling timeout mechanism.

S420: End.

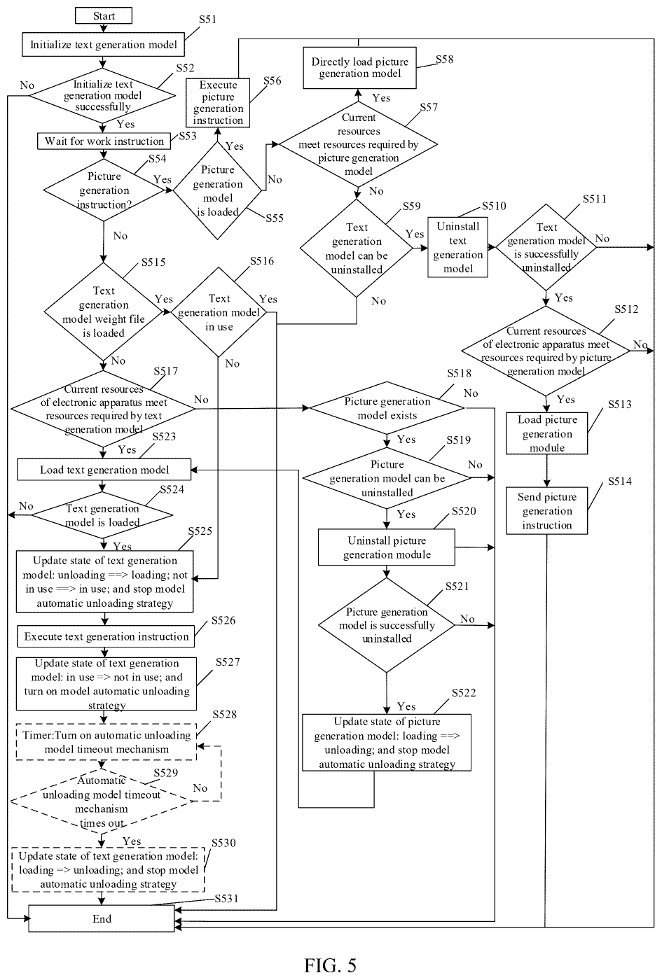

The resource allocation method is described in detail below using the text generation application as an example. FIG. 5 is a flow chart of a resource allocation method for a text generation application. As shown in FIG. 5, the method includes S51 to S531:

S51: Initialize the text generation model.

The text generation application may generate both images and texts, and the text generation model may be the first object.

S52: Determine whether the initialization of the text generation model is successful. If successful, execute S53; otherwise, execute S531.

S53: Wait for the work instruction.

S54: Determine whether the work instruction is a picture generation instruction. If so, execute S55; otherwise, execute S515.

S55: Determine whether the picture generation model is loaded. If loaded, execute S56; otherwise, execute S57.

The picture generation model may be the second object.

S56: The picture generation model executes the picture generation instruction and executes S531.

S57: Determine whether the current resources meet the resource needed by the picture generation model. If so, execute S58; otherwise, execute S59.

S58: Directly load the picture generation model and execute S531.

S59: Determine whether the text generation model is able to be uninstalled. If so, execute S510; otherwise, execute S531.

S510: Uninstall the text generation model.

S511: Determine whether the text generation model is successfully uninstalled. If so, execute S512; otherwise, execute S531.

S512: Determine whether the current resources of the electronic device meet the resource needed by the picture generation model. If so, execute S513; otherwise, execute S531.

S513: Load the picture generation model.

S514: Send the picture generation instruction and execute S531.

S515: Determine whether the text generation model weight file is loaded. If loaded, execute S516; otherwise, execute S517.

S516: Determine whether the text generation model is in use. If not, execute S525; otherwise, execute S531.

S517: Determine whether the current resources of the electronic device meet the resource needed by the text generation model. If so, execute S523; otherwise, execute S518.

S518: Determine whether the picture generation model exists. If so, execute S519; otherwise, execute S531.

S519: Determine whether the picture generation model is able to be uninstalled. If so, execute S520; otherwise, execute S531.

S520: Uninstall the picture generation model.

S521: Determine whether the picture generation model is successfully uninstalled. If uninstalled successfully, execute S522; otherwise, execute S531.

S522: Update the state of the picture generation model: loading==>uninstalling; and stop the model automatic uninstalling strategy.

S523: Load the text generation model.

S524: Determine whether the text generation model is loaded successfully. If loaded successfully, execute S525; otherwise, execute S531.

S525: Update the state of the text generation model: uninstalling==>loading; not in use==>in use; and stop the model automatic uninstalling strategy.

S526: Execute the text generation instruction.

S527: Update the state of the text generation model: in use==>not in use; and turn on the model automatic uninstalling strategy.

S528: Turn on the automatic uninstalling model timeout mechanism.

S529: Determine whether the automatic uninstalling model timeout mechanism has timed out. If it has timed out, execute S531; otherwise, execute S528.

S530: Update the state of the text generation model: loading==>uninstalling; and stop the model automatic uninstalling strategy.

S531: End.

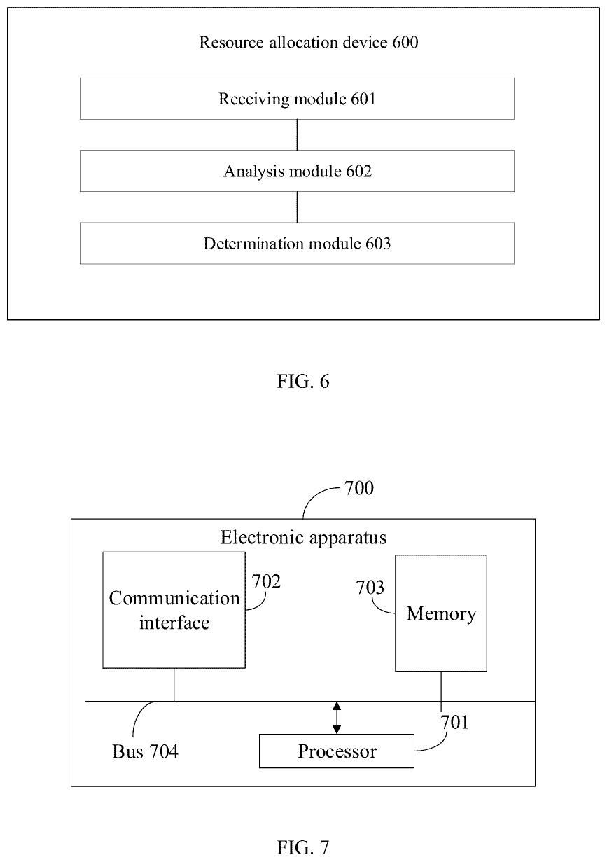

The present disclosure also provides a resource allocation apparatus. In one embodiment, as shown in FIG. 6, which is a schematic structural diagram of a resource allocation apparatus, the resource allocation apparatus 600 includes:
a receiving module 601, configured to receive a work instruction sent by a user;
an analysis module 602, configured to determine a first object corresponding to the work instruction by analyzing the work instruction, where the first object is one of at least two objects in the electronic device; and
a determination module 603, configured to determine a resource allocation manner for at least one object in the electronic device based on the current resources of the electronic device and the resource needed by the first object.

In some embodiments, the determination module 603 may be also configured to execute the work instruction using the first object when the current resources of the electronic device meet the resource needed by the first object and the state of the first object is the first state, where the state of one object in the electronic device includes the first state and the second state, and the resource occupation of the object in the first state is greater than the resource occupation in the second state.

In some embodiments, the determination module 603 may be also configured to allocate the resources occupied by the second object to the first object when the current resources of the electronic device do not meet the resource needed by the first object and the attribute information of the second object of the electronic device meets the preset condition, to meet the resource needed by the first object to execute the work instruction, where the state of the first object is the first state and the resource occupation of the object in the first state is greater than the resource occupation in the second state.

In some embodiments, the attribute information of the second object may include at least one of: the state of the second object or the priority of the second object. The attribute information of the second object satisfying the preset condition may include at least one of: the state of the second object is the second state, or the priority of the first object is higher than the priority of the second object.

In some embodiments, the resource allocation apparatus 600 may further include a configuration module, configured to set the state of the first object to the second state when the first object executes the work instruction, where the resource occupancy of the object in the first state is greater than the resource occupancy in the second state.

In some embodiments, the configuration module may be further configured to: start a first timer after setting the state of the first object to the second state each time; when the first timer times out and no work instruction for the first object is received, release the resources occupied by the first object; and, when the first timer does not time out and a work instruction for the first object is received, stop the first timer, update the state of the first object to the first state, and use the first object to execute the work instruction.

In some embodiments, the resource allocation apparatus 600 may further include a first judgment module, configured to: determine whether the first resource is greater than the resource needed by the first object when the current resource of the electronic device includes the first resource; when the first resource is greater than the resource needed by the first object, determine that the current resource of the electronic device meets the resource needed by the first object; when the first resource is less than the resource needed by the first object, determine the second resource in the current resource of the electronic device, and when the sum of the first resource and the second resource is greater than the resource needed by the first object, determine that the current resource of the electronic device meets the resource needed by the first object; and, when the sum of the first resource and the second resource is less than the resource needed by the first object, determine that the current resource of the electronic device does not meet the resource needed by the first object.

In some embodiments, the resource allocation apparatus 600 may further include a second judgment module, configured to: determine whether the second resource in the current resources of the electronic device is greater than the resource needed by the first object when the current resources of the electronic device do not include the first resource; when the second resource is greater than the resource needed by the first object, determine that the current resources of the electronic device meet the resource needed by the first object; when the second resource is less than the resource needed by the first object, determine that the current resources of the electronic device do not meet the resource needed by the first object.

In some embodiments, the determination module 603 may be also configured to: display a prompt message on the screen of the electronic device, where the prompt message is used to prompt the user whether to allocate the resources occupied by the second object to the first object; in response to the resource allocation operation instruction triggered by the user, allocate the resources occupied by the second object to the first object.

The description of the above apparatus embodiments is similar to the description of the above method embodiments, and has similar beneficial effects as the method embodiments. For technical details not disclosed in the apparatus embodiments of the present disclosure, references may be made to the description of the method embodiments of the present disclosure for understanding.

It should be noted here that the description of each embodiment above tends to emphasize the differences between the embodiments, and the same or similar parts can be referred to each other. The description of the above device, storage medium, computer program and computer program product embodiments is similar to the description of the above method embodiments, and has similar beneficial effects as the method embodiments. For technical details not disclosed in the device, storage medium, computer program and computer program product embodiments of the present disclosure, references may be made to the description of the method embodiments of the present disclosure for understanding.

It should be noted that in the embodiments of the present disclosure, when the above method is implemented in the form of a software function module and sold or used as an independent product, it can also be stored in a computer-readable storage medium. Based on this understanding, a part that is essential to the technical solution of the embodiments of the present disclosure or a part that contributes to the relevant technology can be embodied in the form of a software product, which is stored in a storage medium and includes several instructions for a computer device (which can be a personal computer, a server, or a network device, etc.) to execute all or part of the methods described in each embodiment of the present disclosure. The aforementioned storage medium may include: various media that can store program codes, such as a USB flash drive, a mobile hard disk, a read-only memory (ROM), a magnetic disk or an optical disk. Therefore, the embodiments of the present disclosure are not limited to any specific combination of hardware and software.

One embodiment of the present disclosure provides an electronic device, including a memory and a processor. The memory may be configured to store a computer program that can be run on the processor, and the processor may be configured to implement any resource allocation method provided by various embodiments of the present disclosure when executing the computer program.

One embodiment of the present disclosure provides a computer-readable storage medium, on which a computer program is stored, and the computer program may implement any resource allocation method provided by various embodiments of the present disclosure when executed by the processor. The computer-readable storage medium may be transitory or non-transitory.

One embodiment of the present disclosure provides a computer program product. The computer program product may include a non-transitory computer-readable storage medium storing a computer program, and, when the computer program is read and executed by a computer, some or all of any resource allocation method provided by various embodiments of the present disclosure may be implemented. The computer program product may be implemented by hardware, software or a combination thereof. In an optional embodiment, the computer program product may be embodied as a computer storage medium. In another optional embodiment, the computer program product may be embodied as a software product, such as a software development kit (SDK), etc.

FIG. 7 is a schematic diagram of the hardware structure of an electronic device provided in an embodiment of the present disclosure. As shown in FIG. 7, the electronic device 700 may include: a processor 701, a communication interface 702 and a memory 703. The processor 701 may generally control the overall operation of the electronic device 700. The communication interface 702 may enable the computer device to communicate with other terminals or servers through a network. The memory 703 may be configured to store instructions and applications executable by the processor 701, and may also cache data to be processed or processed by the processor 701 and each module in the electronic device 700 (for example, image data, audio data, voice communication data and video communication data), which can be implemented by flash memory (FLASH) or random access memory (RAM). Data may be transmitted between the processor 701, the communication interface 702 and the memory 703 through the bus 704.

It should be pointed out here that the description of the above storage medium and apparatus embodiments is similar to the description of the above method embodiments, and has similar beneficial effects as the method embodiments. For technical details not disclosed in the storage medium and apparatus embodiments of the present disclosure, references may be made to the description of the method embodiments of the present disclosure for understanding.

It should be understood that the term “one embodiment” or “an embodiment” mentioned throughout the specification means that the specific features, structures or characteristics related to the embodiment are included in at least one embodiment of the present disclosure. Therefore, “in one embodiment” or “in the embodiment” appearing throughout the specification does not necessarily refer to the same embodiment. In addition, these specific features, structures or characteristics may be combined in one or more embodiments in any suitable manner. It should be understood that in various embodiments of the present disclosure, the size of the serial number of each step/process mentioned above does not mean the order of execution. The execution order of each step/process may be determined by its function and internal logic, and should not constitute any limitation on the implementation process of the embodiments of the present disclosure. The serial numbers of the embodiments of the present disclosure are only for description and do not represent the advantages and disadvantages of the embodiments.

It should be noted that in the present disclosure, the term “include,” “comprise” or any other variant thereof is intended to cover non-exclusive inclusion, such that a process, method, article or device including a series of elements includes not only those elements, but also includes other elements not explicitly listed, or also includes elements inherent to such process, method, article or device. In the absence of further restrictions, an element defined by the sentence “including a . . . ” does not exclude the existence of other identical elements in the process, method, article or device including the element.

In the several embodiments provided in the present disclosure, it should be understood that the disclosed devices and methods can be implemented in other ways. The apparatus embodiments described above are only schematic. For example, the division of the units is only a logical function division. There may be other division methods in actual implementation. For example, multiple units or components can be combined, or can be integrated into another system, or some features can be ignored or not executed. In addition, the coupling, direct coupling, or communication connection between the components shown or discussed can be through some interfaces, and the indirect coupling or communication connection of the device or unit can be electrical, mechanical or other forms.

The units described above as separate components may or may not be physically separated, and the components shown as units may or may not be physical units. They may be located in one place or distributed on multiple network units. Some or all of the units may be selected according to actual needs to achieve the purpose of the scheme of this embodiment.

In addition, all functional units in the embodiments of the present disclosure can be integrated into one processing unit, or each unit can be used as a separate unit, or two or more units can be integrated into one unit. The above integrated unit can be implemented in the form of hardware or in the form of hardware plus software functional units.

Those skilled in the art can understand that all or part of the steps of implementing the above method embodiments can be completed by hardware related to program instructions, and the above program may be stored in a computer-readable storage medium. When the program is executed, the steps of the above method embodiments may be executed; and the above storage medium may include: a mobile storage device, a read-only memory, a magnetic disk or an optical disk, etc., which can store program codes.

Alternatively, when the above integrated unit of the present disclosure is implemented in the form of a software functional module and sold or used as an independent product, it can also be stored in a computer-readable storage medium. Based on this understanding, the technical solution of the present disclosure can be essentially or partly embodied in the form of a software product that contributes to the relevant technology. The computer software product is stored in a storage medium and includes several instructions to enable a computer device (which can be a personal computer, a server, or a network device, etc.) to execute all or part of the methods described in the various embodiments of the present disclosure. The aforementioned storage medium may include: various media that can store program codes, such as mobile storage devices, ROM, magnetic disks or optical disks.

The above is only an implementation method of the present disclosure, but the protection scope of the present disclosure is not limited thereto. Those skilled at the art may easily think of changes or replacements within the technical scope disclosed in the present disclosure, which should be covered within the scope of the present disclosure.

What is claimed is:

1. A resource allocation method comprising:
receiving a work instruction;
analyzing the work instruction to determine an object corresponding to the work instruction, the object being one of at least two objects in an electronic device; and
determining a resource allocation manner based on current resources of the electronic device and needed resource that is needed by the object.

2. The method according to claim 1, wherein determining the resource allocation manner includes:
in response to the current resources of the electronic device meeting the needed resource, executing the work instruction using the object, and setting a state of the object to a first state, in which the object occupies more resource than when in a second state.

3. The method according to claim 1, wherein:
the object is a first object in the electronic device; and
determining the resource allocation manner includes:
in response to the current resources of the electronic device not meeting the needed resource and attribute information of a second object of the electronic device meeting a preset condition, allocating a resource occupied by the second object to the first object such that the first object has sufficient resource for executing the work instruction, and setting a state of the first object to a first state, in which the first object occupies more resource than when in a second state.

4. The method according to claim 3, wherein:
the attribute information of the second object includes at least one of a state of the second object or a priority of the second object; and
the attribute information of the second object meeting the preset condition includes at least one of: the state of the second object being the second state or a priority of the first object is higher than the priority of the second object.

5. The method according to claim 3, wherein allocating the resource occupied by the second object to the first object includes:
displaying a prompt message on a screen of the electronic device; and
allocating the resource occupied by the second object to the first object in response to an operation instruction for resource allocation.

6. The method according to claim 1, further comprising, after the work instruction is executed using the object:
switching a state of the object from a first state to a second state, the object occupying more resource in the first state than in the second state.

7. The method according to claim 6, further comprising:
after each time the state of the object is set to the second state, starting a timer;
in response to the timer timing out and no work instruction for the object being received, releasing the resource occupied by the object; and
in response to the timer not timing out and a work instruction for the object being received, stopping the timer, updating the state of the object to the first state, and executing the work instruction using the object.

8. The method according to claim 1, further comprising:
in response to the current resources of the electronic device including a first resource, determining whether the first resource is greater than the needed resource;
in response to the first resource being greater than or equal to the needed resource, determining that the current resources of the electronic device meeting the needed resource;
in response to the first resource being less than the needed resource, determining a second resource among the current resources of the electronic device;
in response to a sum of the first resource and the second resource being greater than or equal to the needed resource, determining that the current resources of the electronic device meeting the resource needed by the first object; and
in response to the sum of the first resource and the second resource being less than the needed resource, determining that the current resources of the electronic device not meeting the needed resource.

9. The method according to claim 1, further comprising:
in response to the current resources of the electronic device not including a first resource, determining whether a second resource in the current resources of the electronic device is greater than or equal to the needed resource;
in response to the second resource being greater than or equal to the needed resource, determining that the current resources of the electronic device meet the needed resource; and
in response to the second resource being less than the needed resource, determining that the current resources of the electronic device do not meet the needed resource.

10. An electronic device comprising:
a processor; and
a memory storing a computer program that, when executed by the processor, causes the processor to:
receive a work instruction;
analyze the work instruction to determine an object corresponding to the work instruction, the object being one of at least two objects in the electronic device; and
determine a resource allocation manner based on current resources of the electronic device and needed resource that is needed by the object.

11. The electronic device according to claim 10, wherein the computer program further causes the processor to, when determining the resource allocation manner:
in response to the current resources of the electronic device meeting the needed resource, execute the work instruction using the object, and set a state of the object to a first state, in which the object occupies more resource than when in a second state.

12. The electronic device according to claim 10, wherein:
the object is a first object in the electronic device; and
the computer program further causes the processor to, when determining the resource allocation manner:
in response to the current resources of the electronic device not meeting the needed resource and attribute information of a second object of the electronic device meeting a preset condition, allocate a resource occupied by the second object to the first object such that the first object has sufficient resource for executing the work instruction, and set a state of the first object to a first state, in which the first object occupies more resource than when in a second state.

13. The electronic device according to claim 12, wherein:
the attribute information of the second object includes at least one of a state of the second object or a priority of the second object; and
the attribute information of the second object meeting the preset condition includes at least one of: the state of the second object being the second state or a priority of the first object is higher than the priority of the second object.

14. The electronic device according to claim 12, wherein the computer program further causes the processor to, when allocating the resource occupied by the second object to the first object:
display a prompt message on a screen of the electronic device; and
allocate the resource occupied by the second object to the first object in response to an operation instruction for resource allocation.

15. The electronic device according to claim 10, wherein the computer program further causes the processor to, after the work instruction is executed using the object:
switch a state of the object from a first state to a second state, the object occupying more resource in the first state than in the second state.

16. The electronic device according to claim 15, wherein the computer program further causes the processor to:
after each time the state of the object is set to the second state, start a timer;
in response to the timer timing out and no work instruction for the object being received, release the resource occupied by the object; and
in response to the timer not timing out and a work instruction for the object being received, stop the timer, update the state of the object to the first state, and execute the work instruction using the object.

17. The electronic device according to claim 10, wherein the computer program further causes the processor to:
in response to the current resources of the electronic device including a first resource, determine whether the first resource is greater than the needed resource;
in response to the first resource being greater than or equal to the needed resource, determine that the current resources of the electronic device meeting the needed resource;
in response to the first resource being less than the needed resource, determine a second resource among the current resources of the electronic device;
in response to a sum of the first resource and the second resource being greater than or equal to the needed resource, determine that the current resources of the electronic device meeting the resource needed by the first object; and
in response to the sum of the first resource and the second resource being less than the needed resource, determine that the current resources of the electronic device not meeting the needed resource.

18. The electronic device according to claim 10, wherein the computer program further causes the processor to:
in response to the current resources of the electronic device not including a first resource, determine whether a second resource in the current resources of the electronic device is greater than or equal to the needed resource;
in response to the second resource being greater than or equal to the needed resource, determine that the current resources of the electronic device meet the needed resource; and
in response to the second resource being less than the needed resource, determine that the current resources of the electronic device do not meet the needed resource.

19. A non-transitory computer-readable storage medium storing a computer program that, when executed by a processor, causes the processor to:
receive a work instruction;
analyze the work instruction to determine an object corresponding to the work instruction, the object being one of at least two objects in an electronic device; and
determine a resource allocation manner based on current resources of the electronic device and needed resource that is needed by the object.

20. The storage medium according to claim 19, wherein the computer program further causes the processor to, when determining the resource allocation manner:
in response to the current resources of the electronic device meeting the needed resource, execute the work instruction using the object, and set a state of the object to a first state, in which the object occupies more resource than when in a second state.
